(19) United States
(12) Patent Application Publication
(10) Pub. No.: US 2020/0251300 A1
(43) Pub. Date: Aug. 6, 2020

(54) MAGNETRONS

(71) Applicant: Teledyne e2v (UK) Limited, THOUSAND OAKS, CA (US)

(72) Inventor: David Rowlands, Essex (GB)

(73) Assignee: Teledyne e2v (UK) Limited, THOUSAND OAKS, CA (US)

(21) Appl. No.: 16/777,542

(22) Filed: Jan. 30, 2020

(30) Foreign Application Priority Data
Jan. 31, 2019 (GB) 1901384.6

(51) Int. Cl. H01J 25/50; H01J 23/14; H05B 6/64; H01J 23/05

(52) U.S. Cl. CPC H01J 25/50; H01J 23/05; H05B 6/64; H01J 23/14

(57) ABSTRACT

A magnetron includes a cathode and a cathode supply lead structure connected to the cathode. A connector is included for electrically connecting to the lead structure and adapted for connection to an external power supply. An electrically conductive casing surrounds the connector. Electrically insulating material is included within the casing and surrounds the connector. The insulating material may be potting material.

### FIELD OF THE INVENTION

This invention relates to magnetrons.

### BACKGROUND

A magnetron is a microwave power source in which electrons travel in a vacuum between a cathode and an anode in a magnetic field. Energy is built up in resonance cavities due to the electron movement and extracted from the magnetron for the required application. In higher power systems, the potential difference between the cathode and anode may be tens of kilovolts. Usually, the anode is earthed and the cathode held negative with respect to the anode, the cathode being connected via a cathode lead structure to an external power source to maintain the correct cathode voltage and often also to supply heater current for a cathode heater. At higher output power levels there may be issues concerning RF leakage, electrical breakdown and accessibility of high voltage parts to users.

### BRIEF SUMMARY

According to a first aspect of the invention, a magnetron comprises: a cathode; a cathode supply lead structure connected to the cathode; a connector for electrically connecting to the lead structure and adapted for connection to an external power supply; an electrically conductive casing surrounding the connector; and electrically insulating material included within the casing and at least partially surrounding the connector.

Use of the electrically insulating material and including the connector as an integral part of the magnetron provide a particularly compact device. This is valuable for applications such as radiotherapy machines where the magnetron is mounted on a moving gantry and space is limited. The socket casing creates a controlled environment where the electrically insulating material improves voltage hold-off, prevents ionization of air and reduces electromagnetic leakage, enabling the magnetron to be operated at relatively high voltages with smaller path lengths between parts of the magnetron at high potential differences. For example, in one embodiment, the magnetron is operable with a cathode voltage in the range of 20 kV to 120 kV. The improved breakdown characteristics from the invention are advantageous where the magnetron is deployed at altitude, for example, between 3000 and 5000 metres above sea level. The compact size eases shipping and handling and requires less warehouse space than might otherwise be the case.

RF leakage from cathode supply lead structure is significantly reduced by the casing, such that there is no risk of interference with external system elements.

In one embodiment, the casing is earthed and may be electrically connected to the anode. This eliminates the need for a user to provide/maintain external clearances to the magnetron. This allows a system incorporating the magnetron to be more compact. An earthed casing also eliminates the presence of exposed high voltage terminals which may otherwise present a risk to personnel. The casing may be integral with the connector. The connector may be positioned in different locations relative to the casing. For example, in one embodiment it is arranged on the longitudinal axis of a cylindrical casing. In another embodiment, it is integral with the cylindrical wall of a cylindrical casing. This ability to re-position the connector gives improved design flexibility and can also be useful when retrofitting the magnetron into a pre-existing system.

In one embodiment, the electrically insulating material at least partially surrounds the cathode supply lead structure. The electrically insulating material may be, for example, at least one of: silicone rubber; ferrite-loaded rubber; resin; oil; and arc suppressant gas. Other materials may also be suitable. Some insulating materials may also provide RF absorption, reducing the risk of RF energy building up within the casing. A combination of insulating materials may be used together, for example, solid insulating material around part of the magnetron and arc suppressant gas being included in the remainder of the casing volume.

In one embodiment, the electrically insulating material is a first solid material surrounded by a second resiliently deformable solid material. The first solid material may be arranged, for example, to closely conform to parts at cathode potential to give good breakdown and leakage performance and the second solid material provides cushioning to reduce movement and allow for thermal expansion during use.

Where the insulating material is a solid, it may encapsulate at least part of the lead structure.

The insulating material may be at least two sections joined together, for example, two sections could be pushed together when the device is assembled rather than being provided a single block of insulator. This can be useful in allowing access for maintenance purposes, for example, and for manufacturing the magnetron.

In one embodiment, the casing is in two separable sections. This facilitates manufacture and access to the cathode supply lead structure. An RF seal may be included at the join between the casing sections. The seal may be a gasket, tape, weld, RF choke or take some other form. The casing may be in more than two separable sections.

In one embodiment, the connector comprises a socket adapted to receive a male external power connector. In another embodiment, the connector comprises a plug adapted to receive a female external power connector. A connector may include both a socket and a plug or only a socket or only a plug. A connector allowing connection using a plug and socket configuration can afford a secure mechanism and ease of use for an operator when connecting to an external power supply.

In one embodiment, the cathode supply lead structure is radially extensive relative to the cathode, sometimes referred to as a sidearm arrangement. The sidearm insulator can be glass or ceramic but ceramic permits the sidearm to be shorter in length giving a more compact device. In an alternative arrangement, the cathode supply lead structure is arranged in the direction of the cathode longitudinal axis.

In one embodiment, the cathode supply lead structure comprises two substantially parallel conductors.

In one embodiment, a container is located between the connector and the cathode supply lead structure and at least one electrical component is housed within the container. The electrically insulating material may surround the container to prevent or reduce the risk of voltage breakdown and RF leakage. The container may be electrically conductive and at cathode supply voltage during operation.

In one embodiment, a fixing mechanism is included on the casing for securing an external conductor from the external power supply.

A magnetron in one embodiment is operable at a current of between 0 to 1 kA.

In one embodiment, at least one electrical component is enclosed within the casing and forms part of the magnetron and cathode supply circuit. The component or components may include resistors and capacitors that form an integrated matching circuit for the magnetron when the magnetron is connected to an external modulator. This enables the magnetron performance to be matched with the modulator output by matching, for example, characteristics such as voltage, resistance, inductance and capacitance.

According to a second aspect of the invention, a microwave system comprises: a magnetron in accordance with the first aspect of the invention, a power supply and an electrical conductor connecting the power supply to the cathode via the cathode supply lead structure and the connector. The electrical conductor may have earth screening.

### BRIEF DESCRIPTION OF THE DRAWINGS

Some embodiments of the present invention will now be described by way of example only, and with reference to the accompanying drawings, in which:

FIG. 1 schematically illustrates in longitudinal cross-section a magnetron in accordance with the invention;

FIG. 2 schematically illustrates part of a magnetron in accordance with the invention connected to an external supply;

FIG. 3 schematically illustrates an alternative to the embodiment shown in FIG. 2;

FIG. 4 schematically illustrates another alternative to the embodiment shown in FIG. 2;

FIG. 5 schematically illustrates in longitudinal cross-section another magnetron in accordance with the invention;

FIG. 6 schematically illustrates part of a magnetron in accordance with the invention;

FIG. 7 schematically illustrates the exterior of part of a magnetron in accordance with the invention;

FIG. 8 schematically illustrates part of a magnetron in accordance with the invention;

FIG. 9 schematically illustrates a system in accordance with the invention; and

FIG. 10 schematically illustrates another system in accordance with the invention.

### DETAILED DESCRIPTION

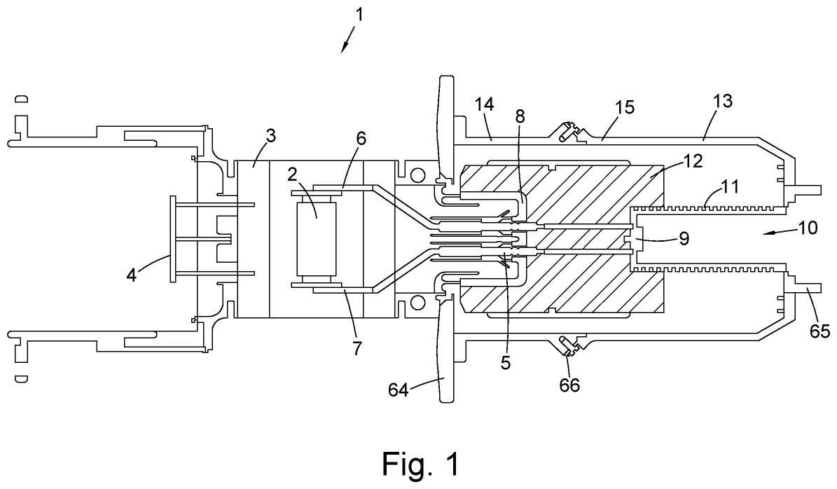

With reference to FIG. 1, a magnetron 1 includes a cathode 2 surrounded by an anode 3. The output of the magnetron is coupled via output 4. The cathode 2 is connected at each end to a cathode supply lead structure 5 having two leads 6 and 7 across which, during operation, a DC heater voltage for the cathode is applied. This voltage is superimposed on the high negative voltage required for operation of the magnetron, in this embodiment about 50 kV. The cathode supply lead structure 5 also mechanically supports the cathode 2.

The leads 6 and 7 are vacuum sealed to a ceramic sidearm arrangement 8 to create the vacuum envelope and are connected to a connector 9 which is configured as a socket 10 to receive an external power supply connection. The socket wall 11 is of dielectric material. The leads 6 and 7 outside the vacuum envelope of the magnetron and the connector 9 are encapsulated in potting material 12 which in this case is silicone rubber.

A cylindrical metal casing 13 surrounds the socket 11 and cathode supply lead structure 5 within the sidearm arrangement 8. The socket 10 is integral with the casing 13 which is electrically connected to the magnetron anode 3 at 64 and the connector 9 at 65, being earthed during operation. The casing is made up of a first part 14 and a second part 15, with a seal between them 66.

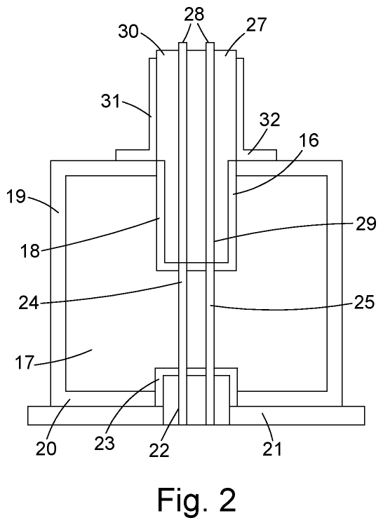

With reference to FIG. 2, a simplified schematic drawing illustrates part of a magnetron including a magnetron socket 16, similar to the configuration shown in FIG. 1 except that in this embodiment, electrically insulating potting material 17 completely surrounds the dielectric wall 18 of the socket 16. An electrically conductive casing 19 surrounds the socket 16 and potting material 17. One wall 20 of the casing is fixed to part of the magnetron anode 21 and is electrically in contact with it, the casing 19 and anode being earthed.

A cathode supply lead structure 22 is sealed to a surrounding ceramic insulator 23 included in a sidearm structure and forming part of the magnetron vacuum envelope. Two leads 24 and 25 of the cathode supply lead structure 22 extend through the solid insulating material 17 to the socket 16.

During operation, an external power supply is connected to the magnetron via an electrical conductor 27 having a plug lead supply structure 28 and which terminates in a plug 29. The plug 29 is configured to conform to the internal shape of the socket 16 and electrically connect the plug lead supply structure 28 and the cathode supply lead structure 22. The plug lead supply structure 28 is surrounded by dielectric material 30 and an electrically conductive sheath 31 with a flange 32 by which the sheath 31 is mechanically fixed to the casing 19 and earthed through electrical contact with the casing 19.

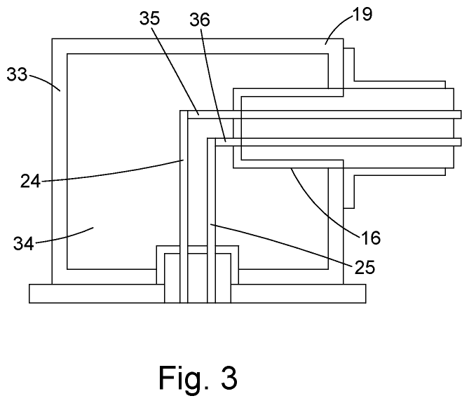

With reference to FIG. 3, in another embodiment, the structure is similar to that shown in FIG. 2 and like reference numerals are used for like parts. In this configuration, the socket 16 is extensive in a transverse direction compared to the cathode leads 24 and 25, the socket 16 being integral with a cylindrical side wall 33 of the casing 19. The cathode leads 24 and 25 terminate within the insulating material 34 and the external plug has a plug supply structure with terminals 35 and 36 which are connected to the cathode leads 24 and 25 respectively via apertures extensive between the cathode leads 35 and 36 and the socket connector 16.

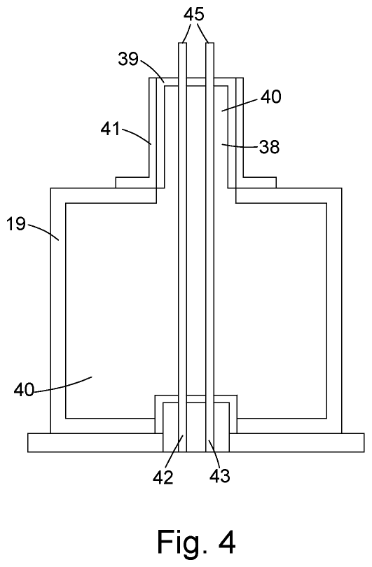

With reference to FIG. 4, in another embodiment, the structure is similar to that shown in FIG. 2 and like reference numerals are used for like parts. In this arrangement, the connector is a plug 38 having dielectric material 39 surrounding electrically insulating material 40 and an outer conductive layer 41. The cathode supply leads 42 and 43 are encapsulated by the insulating material 40 within the casing 19. During operation, an external conductor is connected via a socket supply lead structure 45 which connects to the magnetron plug 38.

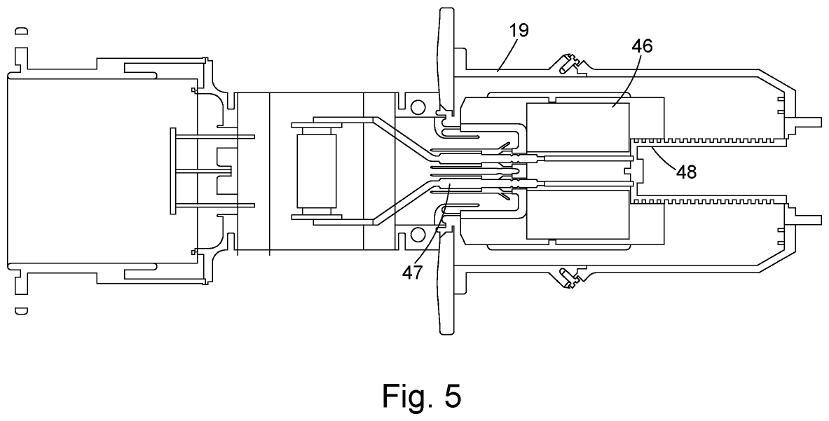

With reference to FIG. 5, a magnetron similar to that shown in FIG. 1 includes a conductive container 46 between the cathode supply lead structure 47 and the socket connector 48. The container 46 houses electrical components (not shown) forming part of the cathode supply circuit. In this embodiment, the electrically insulating material within the casing 19 is an arc-suppressant gas. However, a solid electrically insulating material could be used, as in the embodiment shown in FIG. 1, or an insulating liquid may be used instead.

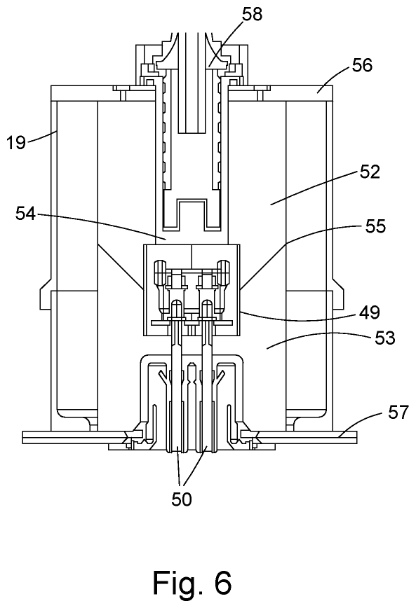

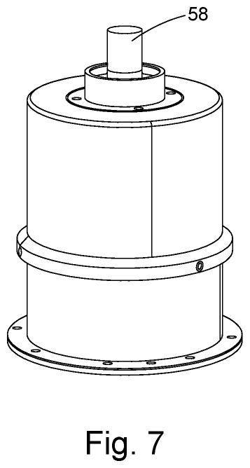

With reference to FIG. 6, a magnetron includes a metal container 49 housing electrical components, the container being at cathode potential. The container 49, cathode lead structure 50, connector 54 are encapsulated by electrically insulating potting material within a casing 19. The potting material 52 is in two sections 52 and 53, joined at 55. One section 52 of the potting material is attached to one section 56 of the casing, and the other section 53 to another section 57 of the casing. FIG. 7 is an exterior view of the magnetron shown in FIG. 6. An external connector 58 is located in the magnetron socket.

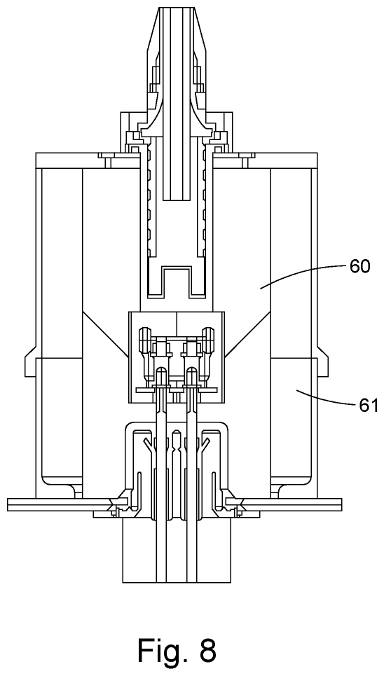

With reference to FIG. 8, a magnetron is similar to that shown in FIG. 6 but in this embodiment, first electrically insulating potting material 60 encapsulates the parts at cathode potential within the casing and second resiliently deformable electrically insulating material 61 surrounds part of the first potting material 60.

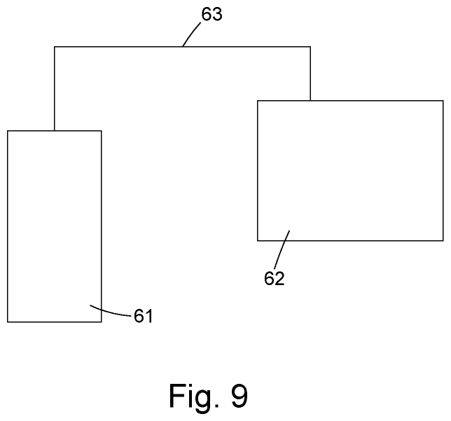

With reference to FIG. 9, a system includes a magnetron 61, which may be for example, any of those shown in FIGS. 1 to 8, and an external power supply 62. An external electrical conductor 63 having earthed screening connects the power supply to the magnetron to provide power to the cathode.

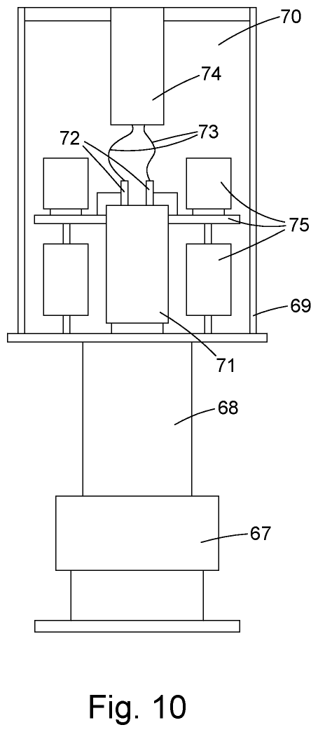

With reference to FIG. 10, a system includes a magnetron 68 and output 67 with an electrically conductive casing 69 defining a socket interface with a connector 74. The casing 69 contains dielectric material 70 and houses a sidearm 71 and cathode leads 72. The cathode leads 72 make an electrical connection via leads 73 to the connector 74 as part of an arrangement of electrical components 75 forming part of the cathode and heater supply circuit. The components 75 include resistors and capacitors included in an integrated matching circuit for the magnetron when the magnetron is connected to an external modulator. This enables the magnetron performance to be matched with the modulator input for efficient operation by matching, for example, characteristics such as voltage, impedance, inductance and capacitance.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A magnetron comprising: a cathode; a cathode supply lead structure connected to the cathode; a connector for electrically connecting to the lead structure and adapted for connection to an external power supply; an electrically conductive casing at least partially surrounding the connector; and electrically insulating material included within the casing and surrounding the connector.

2. The magnetron as claimed in claim 1 and including an anode electrically connected to the casing.

3. The magnetron as claimed in claim 1 wherein the casing is adapted to be earthed during operation of the magnetron.

4. The magnetron as claimed in claim 1 wherein the casing is integral with the connector.

5. The magnetron as claimed in claim 1 wherein the electrically insulating material at least partially surrounds the cathode supply lead structure.

6. The magnetron as claimed in claim 1 wherein the electrically insulating material is at least one of: silicone rubber; ferrite-loaded rubber; resin; oil; and arc suppressant gas.

7. The magnetron as claimed in claim 1 wherein the electrically insulating material is a solid and is at least two sections joined together.

8. The magnetron as claimed in claim 1 wherein the electrically insulating material is a first solid material surrounded by a second resiliently deformable solid material.

9. The magnetron as claimed in claim 1 wherein the casing is in two separable sections.

10. The magnetron as claimed in claim 9 and including an RF seal at a join between the two separable sections.

11. The magnetron as claimed in claim 1 wherein the electrically insulating material is a solid and at least partially encapsulates the cathode supply lead structure.

12. The magnetron as claimed in claim 1 wherein the connector comprises a socket adapted to receive a male external power connector.

13. The magnetron as claimed in claim 1 wherein the connector comprises a plug adapted to receive a female external power connector.

14. The magnetron as claimed in claim 1 wherein the cathode supply lead structure is radially extensive relative to the cathode.

15. The magnetron as claimed in claim 1 wherein the cathode supply lead structure comprises two substantially parallel conductors.

16. The magnetron as claimed in claim 1 and including a container located between the connector and the cathode supply lead structure and at least one electrical component housed within the container.

17. The magnetron as claimed in claim 16 wherein the container is electrically conductive and at cathode supply voltage during operation.

18. The magnetron as claimed in claim 1 and including a fixing mechanism on the casing for securing an external conductor from the external power supply.

19. The magnetron as claimed in claim 1 and operable such that the cathode is maintained in the range 20 kV to 120 kV.

20. The magnetron as claimed in claim 1 and operable at a current of between 0 to 1 kA.

21. The magnetron as claimed in claim 1 and operable at an altitude of between 3000 and 5000 metres above sea level.

22. The magnetron as claimed claim 1 wherein at least one electrical component is enclosed within the casing and forms part of the magnetron and cathode supply circuit.

23. A microwave system comprising:
a magnetron comprising: a cathode; a cathode supply lead structure connected to the cathode; a connector for electrically connecting to the lead structure and adapted for connection to an external power supply; an electrically conductive casing at least partially surrounding the connector; and electrically insulating material included within the casing and surrounding the connector;
a power supply; and
an electrical conductor connecting the power supply to the cathode via the cathode supply lead structure and the connector.

24. The system as claimed in claim 23 wherein the electrical conductor has earth screening.

25. A magnetron comprising: a cathode; a cathode supply lead structure connected to the cathode; a connector for electrically connecting to the lead structure and adapted for connection to an external power supply; an electrically conductive casing at least partially surrounding the connector; electrically insulating material included within the casing and surrounding the connector and an anode, the anode being electrically connected to the casing and the casing being adapted to be earthed during operation of the magnetron.

26. The magnetron as claimed in claim 25 wherein the casing is integral with the connector.

27. The magnetron as claimed in claim 25 and including a container located between the connector and the cathode supply lead structure and at least one electrical component housed within the container.

28. The magnetron as claimed in claim 27 wherein the container is electrically conductive and at cathode supply voltage during operation.

29. The magnetron as claimed claim 25 wherein at least one electrical component is enclosed within the casing and forms part of the magnetron and cathode supply circuit.
